(19) United States
(12) Patent Application Publication
(10) Pub. No.: US 2021/0346233 A1
(43) Pub. Date: Nov. 11, 2021

(54) MASSAGE MECHANISM AND MASSAGE CONTROL DEVICE THEREOF, AND MASSAGE MACHINE

(71) Applicant: Aidepingfang Health Technology (Shanghai) Co., Ltd., Shanghai (CN)

(72) Inventor: YUICHI OKAMOTO, Shanghai (CN)

(21) Appl. No.: 17/384,678

(22) Filed: Jul. 23, 2021

Related U.S. Application Data
(63) Continuation of application No. PCT/CN2019/123202, filed on Dec. 5, 2019.

(30) Foreign Application Priority Data
Oct. 16, 2018 (CN) 201811205290.8

(51) Int. Cl. A61H 7/00

(52) U.S. Cl. CPC A61H 7/007; A61H 2201/1671; A61H 2201/1463; A61H 2205/04; A61H 2205/081; A61H 2205/02; A61H 2201/1207

(57) ABSTRACT

A massage mechanism and a massage control device thereof, and a massage machine are disclosed. The massage mechanism includes a transmission part, a first transmission arm, a second transmission arm, and a motor and a speed reducer that are arranged on the second transmission arm; a massage wheel is mounted on the second transmission arm; the speed reducer includes a power output shaft; and a treatment wheel is eccentrically mounted on the power output shaft. The treatment wheel is eccentrically arranged on the power output shaft, and performs circumferential eccentric reciprocating rotation, so that the treatment wheel can achieve a richer movement effect when being in contact with the body of a person being treated. The moving plane of the treatment wheel is not limited to a plane.

### CROSS-REFERENCE TO RELATED APPLICATIONS

This application is a U.S. continuation of co-pending International Patent Application Number PCT/CN2019/123202, filed on Dec. 5, 2019, which claims the benefit and priority of Chinese Patent Application Number 201811205290.8, filed on Oct. 16, 2018 with China National Intellectual Property Administration, the disclosures of which are incorporated herein by reference in their entireties.

### TECHNICAL FIELD

The present disclosure relates to the technical field of massage equipment, and particularly relates to a massage mechanism and a massage control device thereof, and a massage machine.

### BACKGROUND

As illustrated in FIG. 1 and FIG. 2, for a traditional massage machine 100, a massage mechanism of its massage control device 200 includes a transmission arm 104, a motor 101 mounted on the transmission arm 104, a speed reducer 102 and treatment wheels 103. The treatment wheels 103 are mounted in such a way of all being concentric with a power output shaft 105. The treatment wheels 103 rotate with the power output shaft 105 serving as a center of rotation and moves up and down on the back of a person being treated. A treatment path and speed are relatively flat and monotonous. The massage machine makes the person being treated feel ordinary and has a relatively poor treatment effect. Therefore, the present disclosure provides a massage mechanism that can realize multi-angle and multi-directional massage modes, so as to improve the comfort level of massage and achieve a better therapeutic effect.

### SUMMARY

The technical problem to be solved by the present disclosure is that all treatment wheels of an existing massage machine are concentric with a power output shaft, so that the massage effect is poor.

In order to solve the above-mentioned technical problem, the technical solution of the present disclosure provides a massage mechanism. The massage mechanism includes a transmission part that is rotatably connected with a first transmission arm, a second transmission arm connected with the first transmission arm, and a motor and a speed reducer which are arranged on the second transmission arm and are connected with each other. A massage wheel is mounted on the second transmission arm. The speed reducer is provided with a power output shaft, and a treatment wheel is eccentrically mounted on the power output shaft.

Optionally, the first transmission shaft does clockwise or anticlockwise arc rotation taking the transmission part as a center of rotation.

Optionally, the massage wheel is rotatably mounted on the second transmission arm.

In order to solve the above-mentioned technical problems, the technical solution of the present disclosure further provides a massage control device including any of the foregoing massage mechanisms.

In order to solve the above-mentioned technical problems, the technical solution of the present disclosure further provides a massage machine including the foregoing massage control device.

The beneficial effects of the technical solutions of the present disclosure are as follows:

In the technical solution of the present disclosure, the treatment wheel is eccentrically arranged on the power output shaft, and the treatment wheel does circumferentially eccentric reciprocating rotation, so that the treatment wheel can achieve a richer movement effect when it is in contact with the body of a person being treated; furthermore, the moving plane of the treatment wheel is not limited to a plane, but a purpose of a curved massage path is achieved; the treatment movement and the treatment speed of the massage wheel and the treatment effect are diversified by means of a massage path generated by the circumferentially eccentric reciprocating rotation of the treatment wheel and changes in a treatment angle and speed on the body of the person being treated; and a more plentiful movement combination and a combination of linear and nonlinear treatment speeds can be provided, so as to improve the body feeling of the person being treated on a massage component and enhance the effect of the massage component.

### BRIEF DESCRIPTION OF THE DRAWINGS

FIG. 1 is a schematic structural diagram of a massage machine in the prior art;

FIG. 2 is a schematic structural diagram of a massage mechanism in the prior art;

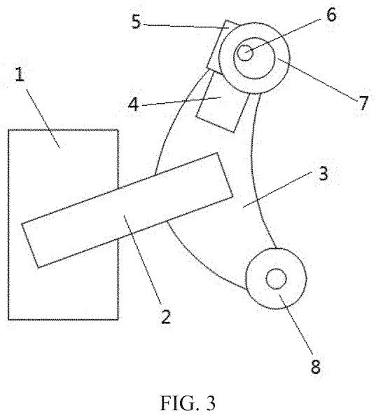

FIG. 3 is a schematic structural diagram of a massage mechanism in the embodiments of the present disclosure;

FIG. 4 and FIG. 5 are another two schematic structural diagrams of a massage mechanism in the embodiments of the present disclosure;

FIG. 6, FIG. 7, FIG. 8 and FIG. 9 are schematic diagrams of positional relationships between a treatment wheel and a speed reducer as well as between the treatment wheel and a power output shaft in the embodiments of the present disclosure; and

FIG. 10 is a schematic diagram of a usage state of the treatment wheel in the massage mechanism in the present embodiment.

### DESCRIPTION OF THE EMBODIMENTS

The present disclosure is further described below in combination with the accompany drawings and specific embodiments that are not intended to limit the present disclosure.

In addition, the terms “first” and “second” are only for the purpose of description, and may not be understood as indicating or implying the relative importance or impliedly indicating the number of technical features indicated. Therefore, features defined by “first” and “second” can explicitly instruct or impliedly include one or more features. In the description of the present disclosure, unless expressly specified otherwise, the meaning of the “plurality” is two or more than two.

In the description of the present disclosure, unless otherwise explicitly specified and defined, the terms “installed”, “coupled” “connected” and “fixed” shall be understood broadly, and may be, for example, fixedly connected, or detachably connected, or integrally connected, or mechanically connected, or electrically connected, or directly connected, or indirectly connected through an intermediate medium, or interconnection between two elements. Those of ordinary skill in the art can understand the specific meanings of the above terms in the present disclosure according to specific situations.

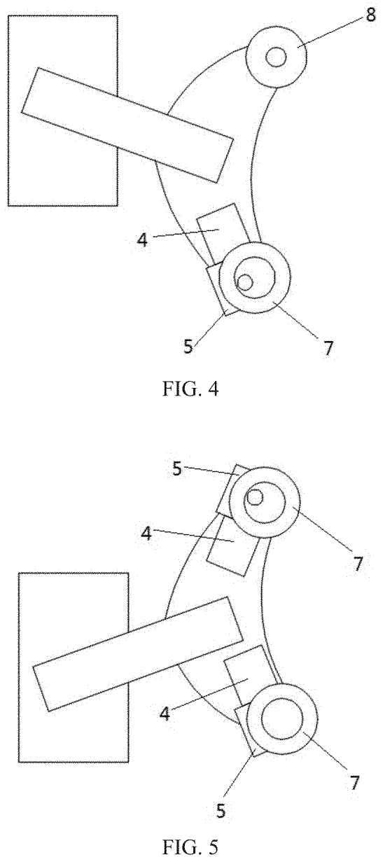

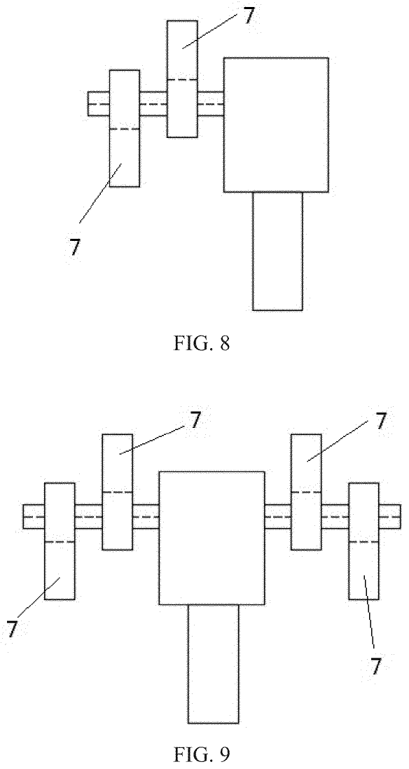

Referring to FIG. 3 and FIG. 6, a massage mechanism according to one embodiment is illustrated, including a transmission part 1 that is rotatably connected with a first transmission arm 2 fixedly connected with a second transmission arm 3 (of course, in other embodiments, the first transmission arm 2 and the second transmission arm 3 can also be set to be relatively rotatable structures; the second transmission shaft 3 does clockwise or anticlockwise arc rotation taking the first transmission shaft 2 as a center of rotation, so that a comovement relation among the transmission part 1, the first transmission arm 2 and the second transmission arm 3 is added, which brings a variety of movement changes, thereby realizing massage experience in more angles), and a motor 4 and a speed reducer 5 which are arranged on the second transmission arm 3 and are connected with each other; and a massage wheel 8 is mounted on the second transmission arm 3. The speed reducer 5 is provided with a power output shaft 6, and a treatment wheel 7 is eccentrically mounted on the power output shaft 6.

In the present embodiment, typically, the second transmission arm 3 is crescent-shaped (in other embodiments, the structure of the second transmission arm 3 is not limited to the crescent shape, and it may also be of other shapes, such as a rectangle, an ellipse and a conical shape), and the treatment wheel 7 and the massage wheel 8 are respectively located at two ends of the crescent-shaped structure of the second transmission arm 3.

In the present embodiment, the first transmission shaft 2 does clockwise or anticlockwise arc rotation taking the transmission part 1 as a center of rotation.

In the present embodiment, the massage wheel 8 is rotatably mounted on the second transmission arm 3.

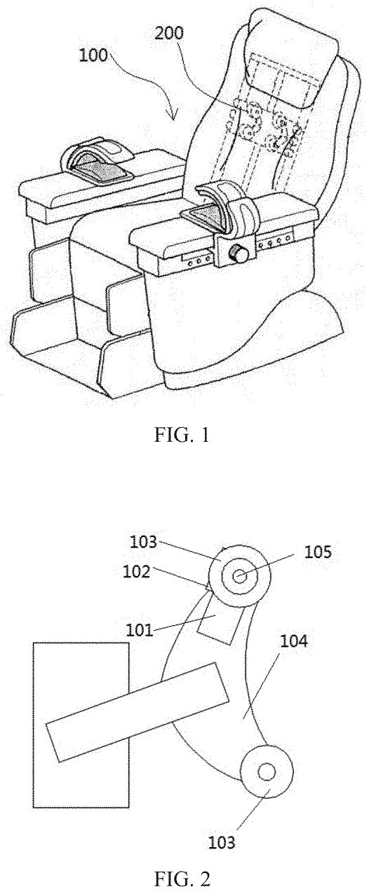

In the present embodiment, a massage control device is further included, which includes any of the foregoing massage mechanisms. The mounting position of the massage mechanism is basically consistent with the position in FIG. 1, and both are in a back rest of the massage machine 100.

The present embodiment further includes a massage machine, including the above-mentioned massage control device.

The present embodiment further includes a working method of a massage mechanism. The working method is:

A motor is initiated to control a speed reducer to drive a power output shaft to rotate; the power output shaft drives a treatment mechanism to do circumferentially eccentric reciprocating rotation; and the treatment wheel and a massage wheel massage a person being treated.

The features and functions of the present disclosure are further illustrated by means of the following explanation.

In the present embodiment, the following detailed description is made by taking the massage mechanism of FIG. 3 as an example.

The transmission part 1 can be fixedly mounted in the massage control device in the back rest of the massage machine; the first transmission arm 2 is connected with the transmission part 1, and does an arc rotation motion taking the transmission part 1 as a center of rotation (the speed reducer (not shown) is mounted on the transmission part 1, and the first transmission arm 2 is connected with the speed reducer and is driven by the speed reducer to move to realize the arc rotation motion taking the transmission part 1 as a center of rotation); and the second transmission arm 3 is connected with the first transmission arm 2 and does the arc rotation motion taking the first transmission arm 2 as a center of rotation. The massage wheel 8 is rotatably mounted on the second transmission arm 3, and an end of the second transmission arm 3 relative to the massage wheel 8 is provided with the motor 4 and the speed reducer 5; the treatment wheel 7 is eccentrically arranged on the power output shaft 6 of the speed reducer 5, and does circumferentially eccentric reciprocating rotation taking the power output shaft 6 as a center of rotation, so that the treatment wheel can achieve a similar “shiatsu” effect when it is in contact with a human body (the “shiatsu” means that when a pericenter of the treatment wheel 7 is in contact with the human body, its apocenter is in contact with the human body after the treatment wheel rotates 180 degrees, and it is the pericenter again that is in contact with the human body after 180 degrees; and since a distance difference is reserved between the pericenter and the apocenter, people will have a tactile sense of “press, not press, press, not press . . . ” in the continuous rotation process of the treatment wheel, thus generating the similar “shiatsu” effect). Furthermore, in the process that the whole massage mechanism moves up and down in a reciprocating manner in the back rest, the moving plane of the treatment wheel is not limited to a plane, and a curved path massage can be realized; by means of changes in a force caused when the treatment wheel does the circumferentially eccentric reciprocating rotation, the massage wheel 8 below the treatment wheel 7 massages a user, so that the user can have a more stereoscopically diversified massage experience, and the comfort level of massage, the massage quality and the treatment effect can be improved.

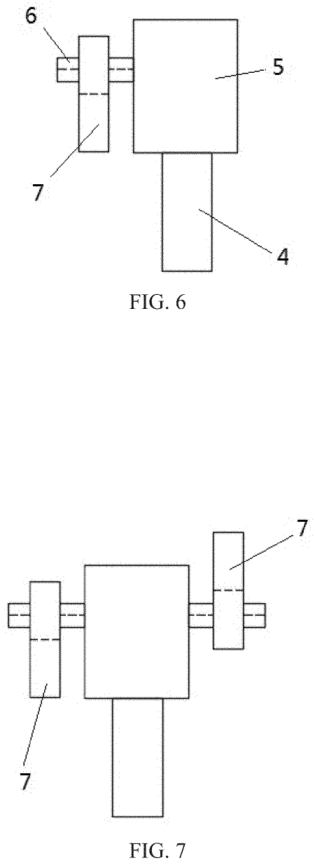

Of course, the structure of the massage mechanism in the present embodiment is not limited to that as shown in FIG. 3. Another two structures of the massage mechanism are as shown in FIG. 4 and FIG. 5. The positions of the massage wheel and the treatment wheel in FIG. 4 are interchanged. The massage wheel is located above the treatment wheel, but the same technical effect can be achieved. In FIG. 5, a structure having two eccentrically disposed treatment wheels 7 is illustrated. Compared with the structure in FIG. 3, this structure cancels the massage wheel 8, and the upper and lower eccentric treatment wheels 7 are used, but the technical effect that is the same as that achieved by the structure in FIG. 3 can also be achieved.

FIG. 6, FIG. 7, FIG. 8 and FIG. 9 are schematic diagrams of positional relationships between the treatment wheel and the speed reducer as well as between the treatment wheel and the power output shaft in the embodiment of the present disclosure. One or two sides of the speed reducer 5 may be provided with eccentric treatment wheels 7, and the number of the eccentric treatment wheels 7 on one side or two sides is not limited. There may be one, two or more eccentric treatment wheels. Of course, a mounting angle between the treatment wheels 7 can be changed to some extent when there are two or more treatment wheels 7. As shown in FIG. 5, FIG. 6 and FIG. 7, the angles between the treatment wheels 7 are respectively staggered to achieve a more diversified and better usage experience.

Of course, the speed reducer in the present embodiment only represents one speed reduction mechanism of a gear connection mechanism connected with the treatment wheel and the power output shaft. Those skilled in the art can understand that any other speed reduction mechanisms, such as a belt wheel transmission mechanism, a crawler type transmission mechanism and a screw rod transmission mechanism, that can realize power output transmission can be used as a substitution of the speed reducer in the present embodiment, and descriptions thereof are omitted here.

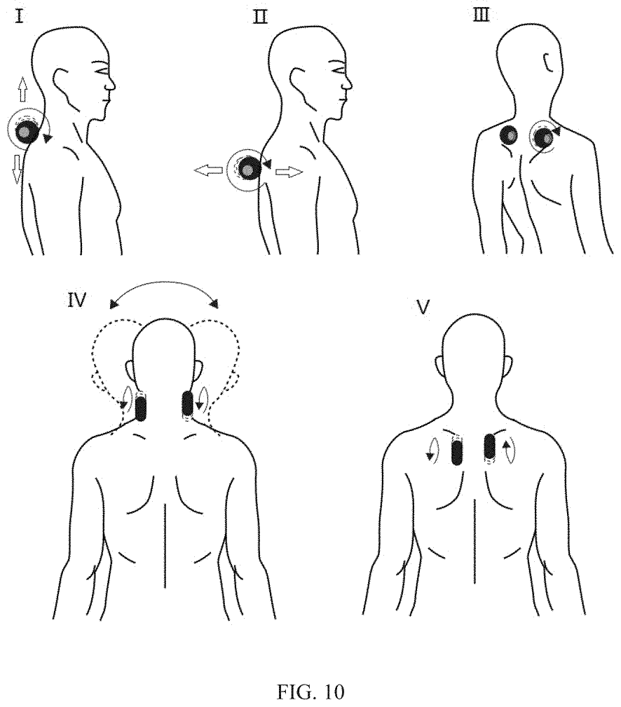

As illustrated in FIG. 10, FIG. 10 illustrates a usage state of the treatment wheel in the massage mechanism. Meanwhile, there are typically two treatment wheels 7 in the massage mechanism in FIG. 10. The number in other embodiments is not limited to two. There may be one, three, four or more treatment wheels.

As illustrated in I of FIG. 10, in the state, the treatment wheels 7 massage the back part of the person being treated. The treatment wheels 7 are eccentrically disposed. In the rotation process of the treatment wheels 7, the treatment wheels 7 at a position, where they are in contact with the person being treated, realize a massage action of “pressing up and down” (an action direction refers to the direction shown in I of FIG. 10).

As illustrated in II of FIG. 10, in the state, the treatment wheels 7 massage the back part of the person being treated. The treatment wheels 7 are eccentrically disposed. In the rotation process of the treatment wheels 7, the treatment wheels 7 at a position, where they are in contact with the person being treated, realize a massage action of “shiatsu front and back” (an action direction refers to the direction shown in II of FIG. 10)

As illustrated in III of FIG. 10, in the state, a left treatment wheel 7 and a right treatment wheel 7 are provided. However, one treatment wheel works while the other one does not work by means of control. That is, the left treatment wheel 7 works, and the right treatment wheel 7 does not work (or the right treatment wheel 7 works, and the left treatment wheel 7 does not work). One of the two treatment wheels 7 (i.e., the left treatment wheel or the right treatment wheel) massages the back part of the person being treated. The treatment wheels 7 are eccentrically disposed. In the rotation process of the treatment wheels 7, the treatment wheels 7 at a position, where they are in contact with the person being treated, realize a massage action of “shiatsu” (an action direction refers to the direction shown in III of FIG. 10)

As illustrated in IV of FIG. 10, in the state, there are a left treatment wheel 7 and a right treatment wheel 7, and the rotation directions of the two treatment wheels 7 are kept consistent. When the treatment wheels 7 massage the person being treated, the person being treated can swing own head and neck parts left and right (or is forced to swing the head and neck parts left and right through the massage machine or other mechanisms), thereby realizing massage of the treatment wheels 7 on all positions of the head and neck parts of the person being treated (the motion directions of the treatment wheels 7 and the swing direction of the head part are as shown in IV of FIG. 10).

As illustrated in V of FIG. 10, the state, there are a left treatment wheel 7 and a right treatment wheel 7, and the rotation directions of the two treatment wheels 7 are opposite. The two treatment wheels simultaneously massage the person being treated. Since the rotation directions of the treatment wheels 7 are opposite, the person being treated will feel a “kneading” action on the back. That is, from V in FIG. 10, the left treatment wheel moves from top to bottom to drive the back muscle to move downwards, and the right treatment wheel moves from bottom to top to drive the back muscle to move upwards. The two treatment wheels drive the back muscle to move upwards and downwards to realize an action similar to “kneading”.

The foregoing merely depict some illustrative embodiments of the present disclosure, and do not therefore limit the implementations and protection scope of the present disclosure. Those skilled in the art should be able to appreciate that solutions obtained by equivalent replacements made by applying the specification of the present disclosure and the contents of the drawings and apparent changes shall all fall within the protection scope of the present disclosure.

What is claimed is:

1. A massage mechanism, comprising a transmission part rotatably connected to a first transmission arm, a second transmission arm connected to the first transmission arm, and a motor and a speed reducer that are arranged on the second transmission arm and are connected to each other, wherein a massage wheel is mounted on the second transmission arm; the speed reducer comprises a power output shaft; and a treatment wheel is eccentrically mounted on the power output shaft.

2. The massage mechanism of claim 1, wherein the first transmission shaft is configured to perform a clockwise or anticlockwise arc rotation with the transmission part as a center of rotation.

3. The massage mechanism of claim 1, wherein the massage wheel is rotatably mounted on the second transmission arm.

4. A massage control device, comprising a massage mechanism, wherein the massage mechanism comprises a transmission part that is rotatably connected to a first transmission arm, a second transmission arm connected to the first transmission arm, and a motor and a speed reducer that are arranged on the second transmission arm and that are connected to each other, wherein a massage wheel is mounted on the second transmission arm, wherein the speed reducer comprises a power output shaft, and a treatment wheel is eccentrically mounted on the power output shaft.

5. The massage control device of claim 4, wherein the first transmission shaft is configured to perform a clockwise or anticlockwise arc rotation with the transmission part as a center of rotation.

6. The massage control device of claim 4, wherein the massage wheel is rotatably mounted on the second transmission arm.

7. A massage machine, comprising the massage control device of claim 4.

8. A massage machine, comprising the massage control device of claim 5.

9. A massage machine, comprising the massage control device of claim 6.
